(19) United States
(12) Patent Application Publication
(10) Pub. No.: US 2022/0410629 A1
(43) Pub. Date: Dec. 29, 2022

(54) TIRE COMPRISING A TREAD

(71) Applicant: COMPAGNIE GENERALE DES ETABLISSEMENTS MICHELIN, Clermont-Ferrand (FR)

(72) Inventors: DANIEL FABING, Clermont-Ferrand (FR); BERTRAND BOISDON, Clermont-Ferrand (FR); JEROME LABROUSSE, Clermont-Ferrand (FR); MARIE-HELENE VANTAL, Clermont-Ferrand (FR)

(21) Appl. No.: 17/774,918

(22) PCT Filed: Nov. 6, 2020
(86) PCT No.: PCT/FR2020/052023

§ 371 Date: May 6, 2022

(30) Foreign Application Priority Data
Nov. 6, 2019 (FR) 1912449

(51) Int. Cl. B60C 11/03; B60C 11/12; B60C 11/13

(52) U.S. Cl. CPC B60C 11/0302; B60C 11/0316; B60C 11/1218; B60C 11/1281; B60C 11/1384; B60C 11/1392; B60C 2011/133

(57) ABSTRACT

A tire comprises a directional tread provided with two edges (25A, 25B) and with a center (C) dividing it into two parts of substantially equal width. The tread comprises, on one of these two parts, blocks (21A, 21B) succeeding one another in a circumferential direction. Each block (21A, 21B) has a leading-edge face (26) and a trailing-edge face (27). The tire comprises, for at least one set of blocks (21A, 21B), at least one set of cavities (29) extending over the trailing-edge face (27) of the set of blocks (21A, 21B). The tread has a bottom surface (24) radially on the inside of the tread, the set of blocks (21A) having a height H, wherein the set of cavities (29) is between the bottom surface (24) of the tread and half of the height H.

### TECHNICAL FIELD

The present invention relates to a tyre for a motor vehicle known as an “all-season” tyre. The invention is more particularly suited to a tyre intended to be fitted to a passenger vehicle or van.

### PRIOR ART

As is known, a tyre known as an “all-season” tyre is a tyre which offers an excellent compromise between grip on snowy ground/wet ground while still maintaining good performance on dry ground. These tyres are intended to run safely all year round, whatever the weather. They have generally attained the 3PMSF (3 Peak Mountain Snow Flake) winter certification attesting to their excellent performance on snowy ground and on wet ground. This certification is notably indicated on one or both of the sidewalls of this type of tyre.

Document WO2016/134988 discloses an all-season tyre having a tread comprising two edges and a centre. Said tread is directional and comprises a plurality of blocks of rubbery material. More particularly, each block of the plurality of blocks has a central zone extending overall over an angle β1, said angle β1 being at least greater than 35 degrees and at most less than 65 degrees to an axial direction. Each block of the plurality of blocks also has an edge zone extending overall over an angle β3 at least greater than 0 degrees and at most less than 10 degrees to said axial direction. Finally, each block of the plurality of blocks has an intermediate zone between the central zone and the edge zone of the block, said intermediate zone making an angle β2 with said axial direction.

There is an ever-present need to improve the performance of all-season tyres both with regard to the compromise between grip on snowy ground and grip on wet ground and with regard to grip on dry ground.

### DISCLOSURE OF THE INVENTION

The present invention seeks to at least partially meet this need.

More specifically, the present invention seeks to improve the compromise between grip on snowy ground/wet ground for an all-season tyre while at the same time improving the performance in terms of grip on dry ground.

The invention relates to a tyre comprising a tread.

A “tyre” means all types of tyre casing made of a rubbery material and which, during running is subjected to an internal pressure or not subjected to such an internal pressure during running (which is the case of an airless tyre casing without compressed air, for example of the Tweel™ type).

More particularly, the invention relates to a tyre comprising a directional tread of width W.

The tread comprises two edges and a centre C. The edges delimit boundaries between this tread and two sidewalls. The centre C divides the tread into two parts of substantially equal width. The tread, on one of its two parts, comprises a plurality of sets of blocks succeeding one another in a circumferential direction.

What is meant by a “circumferential direction” is a direction that is tangential to any circle centred on the axis of rotation. This direction is perpendicular both to an axial direction and to a radial direction.

What is meant by an “axial direction” is a direction parallel to the axis of rotation of the tyre.

What is meant by a “radial direction” is a direction which is perpendicular to the axis of rotation of the tyre (this direction corresponds to the direction of the thickness of the tread at the centre of said tread).

Each set of blocks comprises at least one block. What is meant by a “block” is a raised element delimited by grooves and comprising lateral walls and a contact face, the latter being intended to come into contact with the ground during running. In instances in which the set of blocks comprises just one single block, said set of blocks and said block are merged.

What is meant by a “groove” is a void for which the distance between the walls of material that delimits said groove is greater than 2 mm and of which the depth is greater than or equal to 1 mm.

What is meant by a “sipe” is a void for which the distance between the walls of material that delimits said sipe is less than or equal to 2 mm and of which the depth is greater than or equal to 1 mm.

Each set of blocks extends from one of the edges of the tread towards the centre of said tread with a certain non-zero curvature. The block sets curved in this way define the directional nature of the tread.

Each set of blocks has a total volume VT of rubbery material. What is meant by a “rubbery material” is a polymeric material of the elastomeric compound type, that is to say a polymeric material obtained by mixing at least one elastomer, at least one reinforcing filler and a crosslinking system.

Each set of blocks is delimited by lateral faces, a bottom surface and a contact surface. The total volume VT of rubbery material corresponds to the volume of material contained by the set of blocks between these various boundaries. The total volume VT of rubbery material does not include the volume occupied by the voids (grooves, sipes) in the set of blocks.

Among the lateral faces of the set of blocks a distinction is made between a leading-edge face and a trailing-edge face.

What is meant by the “leading-edge face” is the face of said set of blocks that is first to come into contact with the roadway, in a preferred direction of running of the tyre. The leading-edge face of the set of blocks extends only on the one same side of the set of blocks. Thus, if the set of blocks comprises just one block, the leading-edge face of the set of blocks extends over a lateral wall of this block. If the set of blocks comprises several blocks, the leading-edge face of the set of blocks extends over several lateral walls of different blocks.

What is meant by the “trailing-edge face” is the face of said set of blocks that is last to come into contact with the roadway, in a preferred direction of running of the tyre. The trailing-edge face of the set of blocks extends only on the one same side of the set of blocks. Thus, if the set of blocks comprises just one block, the trailing-edge face of the set of blocks extends over a lateral wall of this block. If the set of blocks comprises several blocks, the trailing-edge face of the set of blocks extends over several lateral walls of different blocks.

For at least one set of blocks, the tyre comprises a set of cavities comprising at least one cavity. What is meant by a “cavity” is a void of the groove or sipe type which opens onto a lateral face of the set of blocks, when the tread is as new.

The set of cavities extends over the trailing-edge face of said set of blocks. The tread has a bottom radially on the inside of said tread, and the set of blocks has a height H. The set of cavities is between the bottom of the tread and half of said height H.

The trailing-edge face of the set of blocks is particularly highly stressed when the vehicle is braking. During this braking, mechanical interactions between the set of blocks and the ground are significant. More particularly, during this braking, the set of blocks is in contact with the ground via the contact surface of the set of blocks. The set of blocks has a tendency to skid along the ground and apply overpressure near the trailing-edge face. This overpressure, if excessively intense, may cause the contact surface to separate from the ground, impairing the braking of the tyre. The set of cavities present on the trailing-edge face reduces the stiffness of this set of blocks. Excessively intense overpressures under braking are reduced. The grip of the tyre on dry ground under braking is thus improved. Furthermore, when the tread reaches a certain level of wear, all of the cavities open onto the tread surface, providing additional voids on this tread surface. These additional voids make it possible to maintain a good grip of the tyre on wet ground or on snowy ground in spite of the wearing of the tread.

In one preferred embodiment, the set of cavities has a concave shape of radius r, where said radius r is at least equal to 0.5 mm and at most equal to 1.5 mm.

In one preferred embodiment, the set of cavities has a depth p, said depth p being at least equal to 0.2 mm and at most equal to 1.5 mm. Preferably, the depth p is at least equal to 0.5 mm and at most equal to 1 mm.

In one preferred embodiment, the set of blocks comprises a sipe extending along the length of said set of blocks. The set of blocks comprises another set of cavities extending from the median sipe towards the leading-edge face of the set of blocks. The other set of cavities is radially at the same level as the set of cavities of the trailing-edge face of said set of blocks.

In one preferred embodiment, the set of blocks comprises a plurality of voids, for example grooves, sipes or cavities, defining a voids volume VE in the set of blocks. The ratio of the voids volume VE to the total volume of rubbery material VT of the set of blocks determining a volumetric void ratio TEV such that TEV=VE/VT. The volumetric void ratio is at least equal to 0.24 and at most equal to 0.35.

In a preferred embodiment, all or some of the voids form one or more sipes on the contact surface of the set of blocks with a sipes density SD. This sipes density SD corresponds to the ratio of a sum of the projected length(s) of the sipe(s) in an axial direction to the product of a pitch P associated with the set of blocks times half the width W of the tread, all multiplied by 1000, such that

$$SD = \frac{{\sum }_{i = 1}^{n} lpyi}{P * W / 2} * 1000 ,$$

where n is the number of sipes in the pattern, and 1 pyi is the projected length of the ith Sipe. The sipes density SD in the set of blocks is at least equal to 10 mm⁻¹ and at most equal to 70 mm⁻¹.

In a preferred embodiment, in the tread when new, the set of blocks has a maximum height at least equal to 5.5 mm and at most equal to 9 mm, and preferably at most equal to 7.5 mm.

In a preferred embodiment, the composition of the rubbery material of the blocks has a glass transition temperature Tg comprised between −40° C. and −10° C. and preferably between −35° C. and −15° C. and a complex dynamic shear modulus G* measured at 60° C. comprised between 0.5 MPa and 2 MPa, and preferably between 0.7 MPa and 1.5 MPa.

A conventional physical characteristic of an elastomeric compound is its glass transition temperature Tg, the temperature at which the elastomeric compound passes from a deformable rubbery state to a rigid glassy state. The glass transition temperature Tg of an elastomeric compound is generally determined during the measurement of the dynamic properties of the elastomeric compound, on a viscosity analyser (Metravib VA4000), according to the standard ASTM D 5992-96. The dynamic properties are measured on a sample of vulcanized elastomeric compound, that is to say elastomeric compound that has been cured to a degree of conversion of at least 90%, the sample having the form of a cylindrical test specimen having a thickness equal to 2 mm and a cross-sectional area equal to 78.5 mm². The response of the sample of elastomeric compound to a simple alternating sinusoidal shear stress, having a peak-to-peak amplitude equal to 0.7 MPa and a frequency equal to 10 Hz, is recorded. A temperature sweep is carried out at a constant rate of rise in temperature of +1.5° C./min. The results utilized are generally the complex dynamic shear modulus G*, comprising an elastic part G′ and a viscous part G″, and the dynamic loss tgδ, equal to the ratio G″/G′. The glass transition temperature Tg is the temperature at which the dynamic loss tgδ reaches a maximum during the temperature sweep. The value of G* measured at 60° C. is indicative of the stiffness of the rubbery material, namely of its resistance to elastic deformation.

In a preferred embodiment, the tyre has a 3PMSF winter certification, said certification being indicated on a sidewall of the tyre.

The present invention will be understood better upon reading the detailed description of embodiments that are given by way of entirely non-limiting examples and are illustrated by the appended drawings, in which:

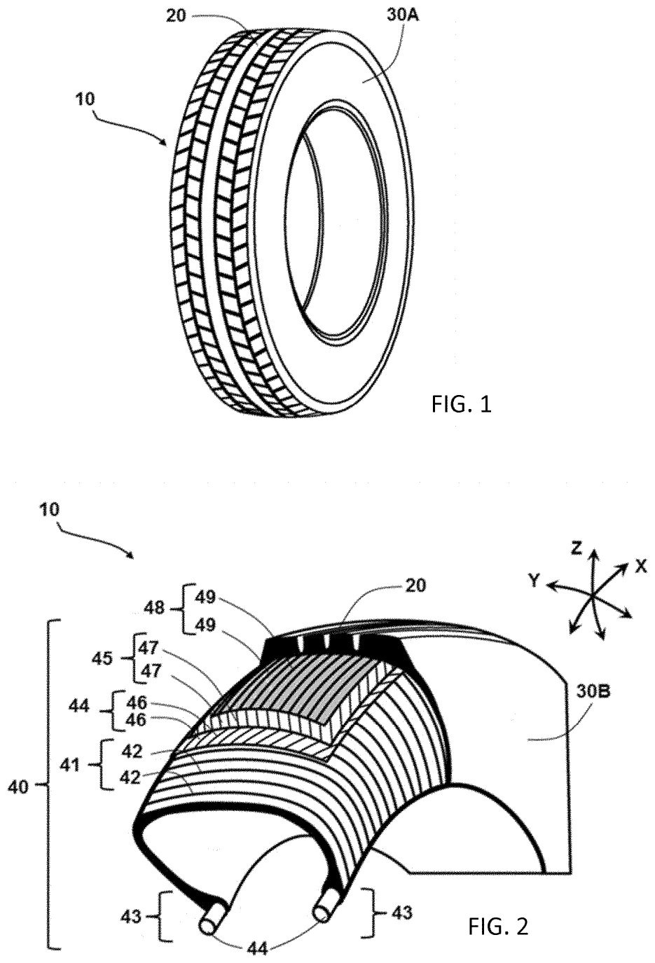

FIG. 1 is a schematic perspective view of a tyre according to the prior art;

FIG. 2 is a schematic perspective view of a partial cross section of a tyre according to another prior art;

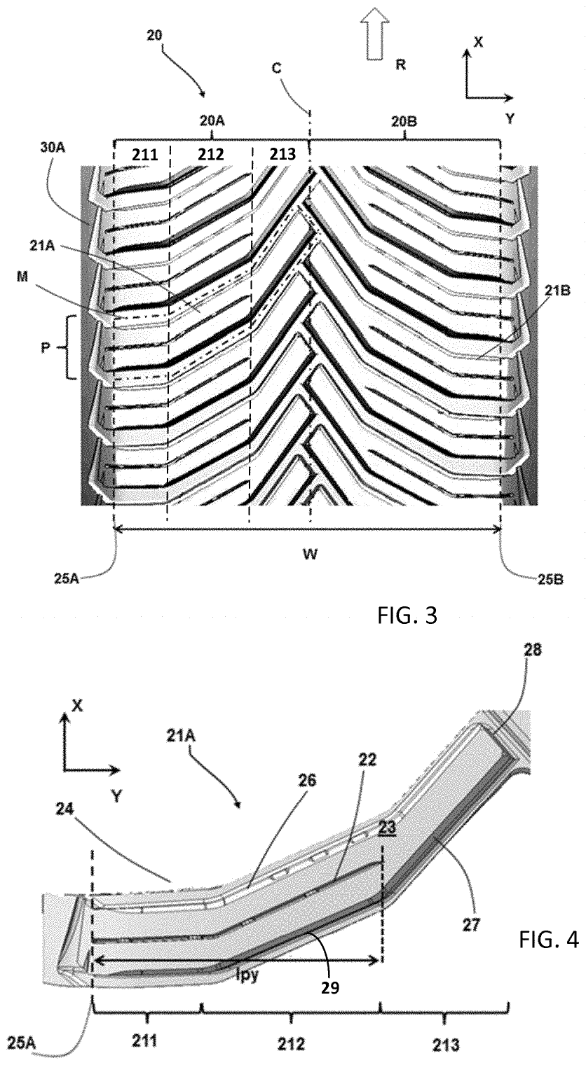

FIG. 3 is a detailed partial view of a tread, when new, of a tyre according to a first embodiment of the invention;

FIG. 4 is an enlarged view of a block of the tread of FIG. 3;

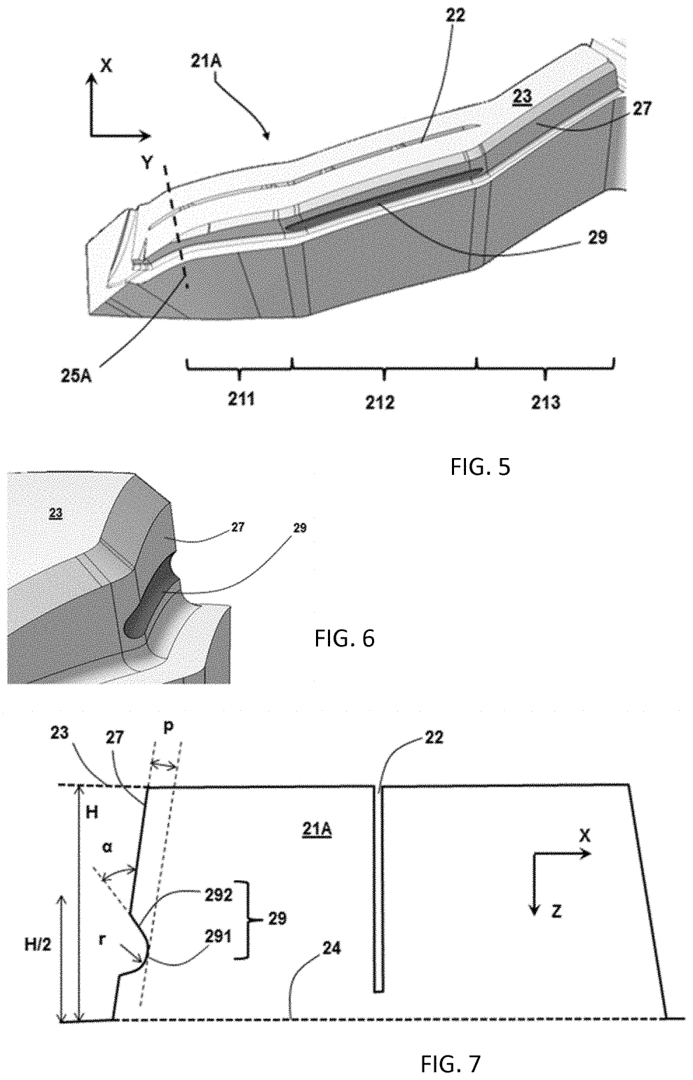

FIG. 5 is a perspective view of the block of FIG. 4;

FIG. 6 is another partial perspective view of the block of FIG. 4, centred on a cavity;

FIG. 7 is a schematic view in radial section of the block of FIG. 4, the section being taken on the cavity of FIG. 6;

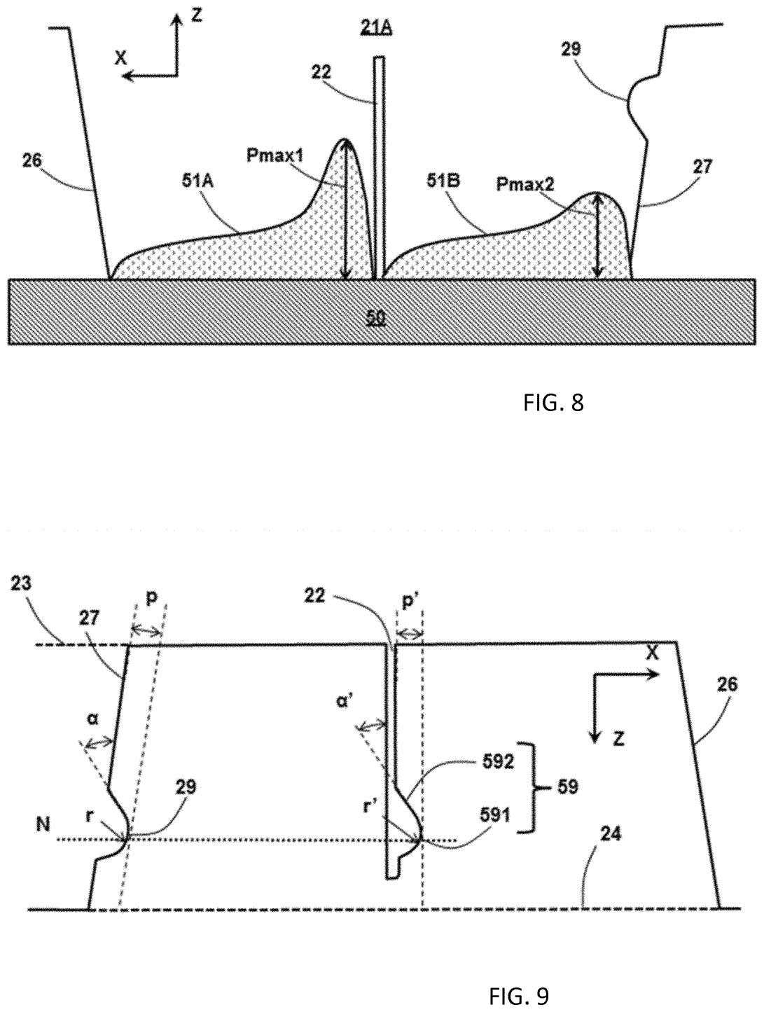

FIG. 8 illustrates the levels of pressure on the block of FIG. 4, under braking on dry ground;

FIG. 9 is a schematic view in cross section through a block of the tread according to a second embodiment of the invention.

The invention is not limited to the embodiments and variants presented and other embodiments and variants will become clearly apparent to a person skilled in the art.

In the various figures, identical or similar elements bear the same references.

FIG. 1 schematically depicts a tyre 10 according to the prior art. This tyre 10 comprises a tread 20 and two sidewalls 30A, 30B (of which just one is depicted here), said tread 20 and said sidewalls 30A, 30B covering a carcass 40 (which is not depicted in FIG. 1). FIG. 2 more particularly details the carcass 40 of a tyre 10 according to the prior art. This carcass 40 thus comprises a carcass reinforcement 41 made up of threads 42 coated with rubber composition, and two beads 43 each comprising annular reinforcing structures 44 (in this instance bead wires) which hold the tyre 10 on a rim (the rim is not depicted). The carcass reinforcement 41 is anchored in each of the beads 43. The carcass 40 additionally comprises a crown reinforcement comprising two working plies 44 and 45. Each of the working plies 44 and 45 is reinforced by filamentary reinforcing elements 46 and 47 which are parallel within each layer and crossed from one layer to the other, making angles comprised between 10° and 70° with the circumferential direction X.

The tyre further comprises a hoop reinforcement 48 arranged radially on the outside of the crown reinforcement. This hoop reinforcement 48 is formed of reinforcing elements 49 that are oriented circumferentially and wound in a spiral. The tyre 10 depicted in FIG. 2 is a “tubeless” tyre. It comprises an “inner liner” made of a rubber composition impervious to the inflation gas, covering the interior surface of the tyre.

FIG. 3 is a detailed partial view of a tread 20 according to the invention. The tread 20 here is as new. This tread 20 comprises two tread parts 20A, 20B of substantially equal width W/2. Each tread part 20A, 20B respectively comprises a plurality of sets of blocks 21A, 21B. The sets of blocks succeed one another in a circumferential direction. More particularly, one set of blocks belongs to a pattern M of pitch P. This pattern M is repeated n times on the circumference of the tyre. This repeat may be an “iso-dimensional” repeat. The tread is then said to be monopitch. As an alternative, this repeat may occur with different magnification factors. The tread is then said to be multipitch.

Each set of blocks 21A, 21B extends respectively from one of the edges 25A, 25B of the tread 20 as far as the central axis C with a non-zero curvature. The central axis C thus comprises an alternation of blocks 21A, 21B originating respectively from the edges 25A, 25B of the tread 20. The tread 20 here is said to be directional, which means to say that the blocks 21A, 21B are specifically arranged to optimize the behavioural characteristics of the tyre depending on a predetermined sense of rotation. This sense of rotation is conventionally indicated by an arrow on the sidewall of the tyre (arrow labelled R in FIG. 3).

In the embodiment of FIG. 1, each set of blocks 21A, 21B comprises a single block. As an alternative, the set of blocks may comprise a number of blocks greater than or equal to 2. In each set of blocks, the blocks are then separated by at least one groove. This groove extends in an axial direction or in an oblique direction having both a non-zero component in the circumferential direction and a non-zero component in the axial direction.

It will be noted that the blocks have a maximum height at least equal to 5.5 mm and at most equal to 9 mm. As a preference, the maximum height of the blocks is at most equal to 7.5 mm. This maximum height is measured for the blocks at the central axis C. It corresponds to the distance between a tread surface 23 (illustrated in FIG. 7 and in FIG. 9) of the tread and a bottom surface 24 (illustrated in FIG. 7 and in FIG. 9). The maximum height of a block corresponds to the maximum depth of the grooves delimiting this block.

What is meant by a “tread surface” 23 of a tread 20 is the surface that groups together all the points of the tyre that will come into contact with the ground under normal running conditions. These points that will come into contact with the ground belong to the contact faces of the blocks. For a tyre, the “normal running conditions” are the use conditions defined by the ETRTO (European Tyre and Rim Technical Organisation) standard. These use conditions specify the reference inflation pressure corresponding to the load-bearing capacity of the tyre as indicated by its load index and its speed rating. These use conditions can also be referred to as “nominal conditions” or “working conditions”.

What is meant by “bottom surface” 24 is a theoretical surface passing through the radially interior points of the grooves of the tread 20. It thus delimits the boundary between the tread 20 and the carcass 40 of the tyre. This bottom surface 24 extends between a first edge 25A and a second edge 25B of the tread 20.

Remember that what is meant by an “edge” 25A, 25B of the tread 20 is the respective boundaries between the tread 20 and the sidewalls 30A, 30B. These two edges 25A, 25B are distant from one another by the value W corresponding to the width of the tread 20. These two edges 25A, 25B are situated at equal distances from the central axis C.

It will also be noted that a winter certification 3PMSF is marked on at least one of the sidewalls 30A, 30B of the tyre.

FIG. 4 is an enlarged view of the set of blocks 21A of FIG. 3. This set of blocks 21A is delimited by a contact surface 23, a bottom surface 24 and lateral faces 26, 27, 28. Among these lateral faces, a distinction is made between a leading-edge face 26, a trailing-edge face 27 and a central face 28. The contact surface 23, the bottom surface 24, the leading-edge face 26, the trailing-edge face 27, the central face 28 and the edge 25A delimit the total volume VT of rubbery material contained in the set of blocks 21A.

The total volume VT of rubbery material contained in the set of blocks 21A can be determined as follows:
the set of blocks 21A is isolated from the rest of the tread;
the set of blocks 21A is weighed when new;
this set of blocks is then planed down until the maximum state of wear is reached, namely until the bottom surface 24 is reached;
the set of blocks 21A thus planed is weighed;
the difference in mass between the set of blocks 21A when new and the set of blocks when worn gives the mass of rubbery material contained in the set of blocks 21A;
the total volume VT of rubbery material is determined from the mass of rubbery material contained in the set of blocks 21A and from the density of this rubbery material.

Another method for determining the total volume VT of rubbery material contained in the set of blocks 21A would be to make full use of the capabilities of 3-D scanners able to directly digitize the volume of a complex object. An example of such a scanner is, for example, the WOLF & BECK TMM-570 metrology machine that employs a laser probe.

The set of blocks 21A here is divided into three main parts, comprising an edge part 211, an intermediate part 212 extending the edge part 211, a central part 213 extending the intermediate part 212. Each of the main parts of the set of blocks 21A here has a main direction of extension specific to it. Thus, the edge part 211 mainly extends overall parallel to the axial direction Y. The central part 213 is steeply inclined with respect to the axial direction Y and the intermediate part 212 has an inclination that is comprised between the inclination of the edge part 211 and the inclination of the central part 213. The set of blocks 21A therefore exhibits a non-zero overall curvature.

In addition, the set of blocks 21A comprises a sipe 22 extending along the length of said set of blocks 21A. More specifically, the sipe 22 extends in the edge part 211 and the intermediate part 212. This sipe 22 follows the inclination of the edge part 211 and of the intermediate part 212. In these two parts 211, 212, the sipe 22 divides the set of blocks 21A into two zones of generally identical width. It will be noted here that the sipe 22 does not extend in the central part 213 of the set of blocks 21A. The sipe 22 has a projected length Lpy in the axial direction Y. It is thus possible to determine a sipes density SD in the set of blocks 21A. This sipes density SD corresponds to the ratio of the projected length Lpy of the sipe 22 to the product of the pitch P of the pattern M containing the set of blocks 21A times half the width W of the tread, all multiplied by 1000, such that

$$SD = \frac{{\sum }_{i = 1}^{n} lpyi}{P * W / 2} * 1000 , .$$

The sipes density SD here is at least equal to 10 mm⁻¹ and at most equal to 70 mm⁻¹.

The set of blocks 21A also comprises a set of cavities 29. This set of cavities 29 is notably visible in FIGS. 5 to 7. The set of cavities 29 here comprises a single cavity extending over the trailing-edge face 27 of the set of blocks 21A. The set of cavities 29 is thus positioned near the bottom surface 24, between said bottom surface 24 and half the height H/2. As a preference, the set of cavities 29 extends in the intermediate part 212 of the set of blocks 21A.

The void volume made up of all the cavities 29 is thus at least equal to 1% of the total volume VT of rubbery material of the set of blocks 21A and at most equal to 5% of said total volume VT of rubbery material.

As is more particularly illustrated in FIG. 7, the set of cavities 29 has a concave overall shape. The set of cavities 29 thus comprises a bottom 291 and an intermediate part 292 positioned between the bottom 291 and the trailing-edge face 27 The bottom 291 is rounded and, viewed in cross section, has a radius r at least equal to 0.5 mm and at most equal to 1.5 mm. The intermediate part 292 provides the connection between the bottom 291 and the trailing-edge face 27. This intermediate part 292 thus extends towards the bottom surface 24, making an angle a with the trailing-edge face 27. This angle a is at least equal to 30° and at most equal to 70°. It will be noted that, in the example of FIG. 7, the trailing-edge face 27 is inclined with respect to a radial direction Z. As a variant, the trailing-edge face 27 is parallel to this radial direction Z.

The set of cavities 29 also has a depth p. This depth p is at least equal to 0.2 mm and at most equal to 1.5 mm. As a preference, the depth p is at least equal to 0.5 mm and at most equal to 1 mm. Finally, the set of blocks 21A has a height H measured between the bottom surface 24 and the contact surface 23. When the tread is new, this height H is at least equal to 5.5 mm and at most equal to 9 mm. As a preference, when the tread is new, the height H is at most equal to 7.5 mm.

FIG. 8 illustrates the effects that the set of cavities 29 has on the levels of pressure applied to the set of blocks 21A under braking on a ground 50. More particularly, FIG. 8 shows a first pressure-distribution diagram 51A and a second pressure-distribution diagram 51B. The first pressure-distribution diagram 51A schematically indicates the distribution of pressure through the set of blocks 21A between the leading-edge face 26 and the sipe 22. In a braking phase, the pressure adopts a maximum value Pmax1 near the sipe 22. The second pressure-distribution diagram 51B schematically indicates the distribution of pressure through the set of blocks 21B between the sipe 22 and the trailing-edge face 27. In a braking phase, the pressure adopts a maximum value Pmax2 near the trailing-edge face 27. It will be noted that the presence of the set of cavities 29 on the trailing-edge face 27 lowers the maximum value Pmax2, bringing it down below the maximum value Pmax1.

FIG. 9 illustrates a second embodiment of the invention in which the set of blocks 21A comprises another set of cavities 59 extending from the median sipe 22 towards the leading-edge face 26 of the set of blocks 21A. This other set of cavities 59 is radially at the same level N as the set of cavities 29 of the trailing-edge face 27 of the set of blocks 21A. This other set of cavities 59 extends from the sipe 22. It comprises at least one cavity. More specifically, the other set of cavities 59 has a concave overall shape. The other set of cavities 59 thus comprises a bottom 591 and an intermediate part 592 positioned between the bottom 591 and the sipe 22. The bottom 591 is rounded and, viewed in cross section, has a radius r′ at least equal to 0.5 mm and at most equal to 1.5 mm. Advantageously, the radius r′ of the other set of cavities 59 is identical to the radius r of the set of cavities 29. The intermediate part 592 provides the connection between the bottom 591 and the sipe 22. This intermediate part 592 dictates the overall direction of extension of the other set of cavities 59 in the set of blocks 21A. The other set of cavities 59 thus extends towards the bottom surface 24, making an angle α′ with the sipe 22. This angle α′ is at least equal to 30° and at most equal to 70°. Advantageously, the angle α′ of the other set of cavities 59 is identical to the angle a of the set of cavities 29.

The other set of cavities 59 also has a depth p′. This depth p′ is at least equal to 0.2 mm and at most equal to 1.5 mm. Preferably, the depth p′ is at least equal to 0.5 mm and at most equal to 1 mm. Advantageously, the depth p′ of the other set of cavities 59 is identical to the depth p of the set of cavities 29.

The set of cavities 29, the other set of cavities 59 and the sipe 22 define a volume VE of voids in the set of blocks 21A. The ratio of this voids volume VE to the total volume of rubbery material VT of the set of blocks determines a volumetric void ratio TEV such that TEV=VE/VT. This volumetric void ratio is at least equal to 0.24 and at most equal to 0.35.

For all the embodiments illustrated in FIGS. 1 to 9, each set of blocks is formed from a rubbery material. In one preferred embodiment, the composition of this rubbery material has a glass transition temperature comprised between −40° C. and −10° C. and preferably between −35° C. and −15° C. and a shear modulus measured at 60° C. comprised between 0.5 MPa and 2 MPa, and preferably between 0.7 MPa and 1.5 MPa.

In one preferred embodiment, the composition of the rubbery material of the sets of blocks is based on at least:
an elastomer matrix comprising more than 50% by weight of a solution SBR bearing a silanol functional group and an amine functional group;
20 to 200 phr of at least one silica;
a coupling agent for coupling the silica to the solution SBR;
10 to 100 phr of a hydrocarbon-based resin having a Tg of greater than 20° C.;
15 to 50 phr of a liquid plasticizer.

The solution SBR in this preferred embodiment is a copolymer of butadiene and styrene, prepared in solution. The characteristic feature thereof is that it bears a silanol functional group and an amine functional group. The silanol functional group of the solution SBR bearing a silanol functional group and an amine functional group may for example be introduced by hydrosilylation of the elastomer chain by a silane bearing an alkoxysilane group, followed by hydrolysis of the alkoxysilane functional group to give a silanol functional group. The silanol functional group of the solution SBR bearing a silanol functional group and an amine functional group may equally be introduced by reaction of the living elastomer chains with a cyclic polysiloxane compound as described in EP 0 778 311. The amine functional group of the solution SBR bearing a silanol functional group and an amine functional group may for example be introduced by initiating polymerization using an initiator bearing such a functional group. A solution SBR bearing a silanol functional group and an amine functional group may equally be prepared by reacting the living elastomer chains with a compound bearing an alkoxysilane functional group and an amine functional group according to the procedure described in patent application EP 2 285 852, followed by hydrolysis of the alkoxysilane functional group to give a silanol functional group. According to this preparation procedure, the silanol functional group and the amine functional group are preferably situated within the chain of the solution SBR, not including the ends of the chain. The reaction producing the hydrolysis of the alkoxysilane functional group borne by the solution SBR to give a silanol functional group may be carried out according to the procedure described in patent application EP 2 266 819 A1 or else by a step of stripping the solution containing the solution SBR. The amine functional group can be a primary, secondary or tertiary amine, preferably a tertiary amine.

The invention is not limited to the embodiments and variants presented and other embodiments and variants will become clearly apparent to a person skilled in the art.

Thus, the set of blocks may comprise three blocks separated by two grooves. The grooves introduce a certain flexibility into the tread, making it come into contact with the ground better.

Thus, the set of cavities may comprise a number of cavities greater than 1. These cavities are therefore aligned along the length of the set of blocks. They can be identical or different in size.

Thus, a set of blocks may comprise a plurality of sipes. The density SD of these sipes in the set of blocks is, however, less than or equal to 70 mm⁻¹.

1.-10. (canceled)

11. A tire comprising a directional tread (20) of width (W),
the tread (20) comprising two edges (25A, 25B) and a center (C) dividing the tread into two parts of substantially equal width,
the tread (20) comprising, on one of the two parts of the tread (20), a plurality of sets of blocks (21A, 21B) succeeding one another in a circumferential direction,
each set of blocks (21A, 21B) extending from one of the edges (25A, 25B) of the tread (20) toward the center (C) of the tread with a certain non-zero curvature,
each set of blocks (21A, 21B) comprising a leading-edge face (26) and a trailing-edge face (27),
wherein the tire comprises, for at least one set of blocks (21A, 21B), at least one set of cavities (29) extending over the trailing-edge face (27) of the set of blocks (21A, 21B), the set of cavities (29) comprising at least one cavity, and
wherein, the tread (20) having a bottom surface (24) radially on an inside of the tread and the set of blocks (21A) having a height H, the set of cavities (29) is between the bottom surface (24) of the tread and half of the height H.

12. The tire according to claim 11, wherein, the set of cavities (29) having a concave shape comprising a bottom (291) of radius r, the radius r is at least equal to 0.5 mm and at most equal to 1.5 mm.

13. The tire according to claim 11, wherein, the set of cavities (29) having a depth p, the depth p is at least equal to 0.2 mm and at most equal to 1.5 mm.

14. The tire according to claim 12, wherein an intermediate part (292) providing a connection between the bottom (291) of radius r and the trailing-edge face (27) extends toward the bottom surface (24) of the tread making an angle a with the trailing-edge face (27) of the set of blocks (21A), the angle a being at least equal to 30° and at most equal to 70°.

15. The tire according to claim 11, wherein the set of blocks (21A) comprises a sipe (22) extending along a length of the set of blocks (21A), and
wherein the set of blocks comprises another set of cavities (59) extending from the median sipe toward the leading-edge face (26) of the set of blocks, the other set of cavities (59) being radially at a same level as the set of cavities of the trailing-edge face of the set of blocks (21A).

16. The tire according to claim 11, wherein, the set of blocks comprising a plurality of voids defining a voids volume VE in the set of blocks, and the ratio of the voids volume VE to a total volume of rubbery material of the set of blocks determining a volumetric void ratio TEV such that TEV=VE/VT, the volumetric void ratio is at least equal to 0.24 and at most equal to 0.35.

17. The tire according to claim 16, wherein, all or some of the voids forming one or more sipes (22) on a contact surface of the set of blocks with a sipes density SD, the sipes density SD corresponding to a ratio of a sum of projected length(s) (1 pyi) of the sipe(s) in an axial direction (Y) to a product of a pitch P associated with the set of blocks (21A) times half the width (W) of the tread, all multiplied by 1000, such that
$$SD = \frac{{\sum }_{i = 1}^{n} lpyi}{P * W / 2} * 1000 ,$$
where n is the number of sipes in the pattern and 1 pyi is the projected length of the ith Sipe, the sipes density SD in the set of blocks is at least equal to 10 mm⁻¹ and at most equal to 70 mm⁻¹.

18. The tire according to claim 11, wherein, in the tread when new, the set of blocks (21A) has a maximum height at least equal to 5.5 mm and at most equal to 9 mm.

19. The tire according to claim 11, wherein the composition of a rubbery material of the blocks has a glass transition temperature Tg comprised between −40° C. and −10° C. between −35° C. and a complex dynamic shear modulus G* comprised between 0.5 MPa and 2 MPa, the measurements being taken under simple alternating sinusoidal shear stress with a peak-to-peak amplitude equal to 0.7 MPa and a frequency equal to 10 Hz, at a temperature of 60° C.

20. The tire according to claim 11, wherein the tire has a 3PMSF winter certification, the certification being indicated on a sidewall (30A, 30B) of the tire.
